(19) United States
(12) Patent Application Publication
(10) Pub. No.: US 2017/0116594 A1
(43) Pub. Date: Apr. 27, 2017

(54) METHOD AND ARRANGEMENT FOR CARRYING OUT A DIGITAL PAYMENT PROCESS

(71) Applicant: Manfred Rietzler, Marktoberdorf (DE)

(72) Inventor: Manfred Rietzler, Marktoberdorf (DE)

(21) Appl. No.: 15/316,923

(22) PCT Filed: Jun. 9, 2015
(86) PCT No.: PCT/IB2015/000892

§ 371 Date: Dec. 7, 2016

(30) Foreign Application Priority Data
Jun. 14, 2014 (DE) 10 2014 008 419.1

(51) Int. Cl. G06Q 20/32

(52) U.S. Cl. CPC G06Q 20/322; G06Q 20/3278

(57) ABSTRACT

The invention relates to a method and an arrangement for carrying out a digital payment process using a mobile radio unit, wherein the mobile radio unit establishes a first data connection to a network server of a clearing centre via a radio interface of the mobile radio unit, wherein the mobile radio unit establishes a second data connection to an RFID data storage medium of an authentication device via an integrated RFID read unit in such a manner that the mobile radio unit is used to transmit authentication data stored on the RFID data storage medium to the network server of the clearing centre in order to give clearance to a reservation or payment process.

The invention pertains to a method for processing a digital payment procedure by using a mobile radio device, wherein the mobile radio device comprises a radio interface providing for a first data link to a network-server of a clearing center.

Beyond that the invention pertains to an arrangement for processing a digital payment procedure comprising a mobile radio device having a radio interface and an integrated RFID-reader device, an authentication device provided with a RFID-data carrier and a network-server of a clearing center.

Transfer systems providing for a wireless transfer between two devices being positioned closely to each other and providing for a data transfer with a global network via radio communication are fairly standardized. On the technical field of near field communication (NFC), particularly there is to mention the data interface as required in ISO/IEC18092, ISO/IEC 21481.

The technical basis of the NFC transmission system is constituted by an NFC data carrier (NFC tag), which consists of a microchip with a data memory carrying information and a coupling element and which, when advancing an NFC reader device, starts to interact with the electromagnetic field emitted by the same in such a way that the information stored on the NFC tag can be read out and processed. In this system configuration, the NFC tag is configured as a purely passive assembly, which obtains its energy from the alternating electromagnetic field of the reader device that initiates the transmission. Here, a data link setup and the data transfer proceed without any further manual configuration of the communicating devices.

New application fields arise due to the fact that the NFC functionality is integrated into mobile radio devices, in order to enable users, simply by advancing an NFC-enabled mobile phone towards a passive NFC data carrier, to make use of services that are provided by a global network to which the mobile phone is connected via its radio interface. Combining the NFC technology with processes of mobile radio transmissions extends the range of capabilities of contactless card systems by making it possible that the data provided by an NFC tag can now be used via the mobile radio network in a comprehensive global network. With respect to future generations of mobile radio devices, it can thus be expected that many mobile phones will be equipped with an NFC data interface. Therefore, the mobile radio device of the future will be capable both of emulating a passive NFC tag that is configured as a contactless smartcard (NFC Card Emulation Mode), and of reading and writing on an NFC tag (NFC Reader/Writer Mode) as well as of exchanging information with peer devices (NFC Peer-to-Peer Mode).

Furthermore, the NFC interface is also specified such that it is compatible with the RFID—(Radio Frequency Identification)—transmission standards ISO 14443 and ISO 15693. Thus, an NFC-enabled device for reading RFID data carrier (RFID tags, RFID transponders) can be used.

From WO 2009/039419 A1 there is known a method and an arrangement for processing a digital payment procedure wherein a mobile phone provides for a data link to a network-server of a clearing center via a radio interface. Furthermore the mobile phone is wireless connected to a credit card via a bluetooth interface, wherein the credit card comprises a power source and provides for a wireless data transfer via a NFC-interface to a pay terminal being provided with a reader device and connected to a clearing center. Thus, for processing payment procedures using the known method additionally to a mobile radio device embodied as a mobile phone there is need for an active credit card being provided with a power source which credit card must have different interfaces, and a pay terminal being connected to the clearing center. Thus, as a condition for processing payment procedures there is need for appropriate pay terminals.

Thus, the present invention is based on the object to provide for a method and an arrangement for processing a digital payment procedure, which method and arrangement simplify processing digital payment procedures and particularly do not require for availability of pay terminals.

As it pertains a method the object is attained in connection with the preamble of claim 1 in that the mobile radio device comprises an integrated RFID-reader device providing for a second data link to a RFID-data carrier of an authentication device, in such a manner, that a data transfer of authentication data stored on the RFID-data carrier to the network-server of the clearing center is performed by the mobile radio device for posting or payment release.

The inventive method enables for the use of the mobile radio device as pay terminal, wherein the mobile radio device simultaneously serves for establishing a data link to the network server of the clearing center. Beyond that the inventive method provides for the use of a passive credit car, i.e. a credit card without own power source. The direct connection of the RFID-data carrier with the network server of the clearing center further renders dispensable the installation of additional safety levels going beyond the authentication data of the RFID-data carrier.

One has to note that the numbering of the data links, for example as first or second data link, is only for distinguishing the different data links and does not indicate any chronological order. Particularly in general one has to assume that the setting of the second data link between the mobile radio device and the RFID-data carrier will precede the setting of the first data link between the mobile radio device and the network server.

According to a first preferred embodiment of the inventive method the authentication device is embodied as a credit card and the authentication of the data or information stored on the RFID-data carrier is performed by the network-server or by an authentication server of the clearing center, which enables using a passive credit card, i.e. a credit card without own power source. As the authentication is independent of the mobile radio device, the mobile radio device only serves for transmitting the authentication data.

According to a second preferred embodiment of the inventive method the authentication device is embodied as a personal identification document and the authentication of the data or information stored on the RFID-data carrier is performed by an authentication server independent of the clearing center. Here too, the authentication is independent of the mobile radio device, which only serves for transmitting the authentication data.

Thus, processing payment procedures do not require unconditionally a credit card which is released from the respective credit card provider as mandatory requirement for the authentication procedure. On the contrary, the authentication can happen on the base of authentication data stored on the RFID-data carrier of an personal identification document or the like, so that the personal identification document can be used as pay card.

It proves to be advantageous, if the data transfer between the RFID-data carrier and the RFID-reader device is performed by a NFC-interface which is integrated in the mobile radio device, the NFC-interface being compatible with a RFID-interface. In the course of the introduction of NFC-enabled mobile radio devices in connection with the RFID compatibility of the NFC-interface one can assume for the future that each owner of a NFC-enabled mobile phone simultaneously will be equipped with a RFID-reader device. Thus, there will be provided for an infrastructure enabling the user to process digital payment procedures “online” in an extraordinary comfortable manner by means of a data link to a network-server of a network via the radio interface of his mobile radio device.

Preferably the data link setup of the second data link is performed automatically upon identification of the RFID-data carrier by the NFC-interface, so that the data link setup must not be performed by the user beforehand.

If the mobile radio device is activated as pay terminal and input data specifying the posting or payment transaction and being entered into the mobile radio device by means of a data input device are transferred to the network-server of the clearing center via the radio interface of the mobile radio device, not only standardized payment procedures can be performed, but payment procedures can be defined individually.

In order to prevent for false input data, it is particularly favorable that upon reception of the transferred data by the clearing center the network-server transfers the received data to the mobile radio device for confirmation, so that there is a control option for the user of the mobile radio device.

Preferably, the data input is performed by a keypad of the mobile radio device.

If the activation of the mobile radio device as pay terminal and the data link setup of the first data link to the network-server via the radio interface is performed by an application software installed on the mobile radio device, the activation does not require for a special configuration of the mobile phone of the user; particularly the activation by the user himself is possible without actions of the phone provider.

Preferably the application software also controls the data transfer of the authentication data from the RFID-data carrier to the network server data via the first and second data link, so that the mobile radio device is an open platform or bridge passing the data from the RFID-data carrier to the network server.

The respective application software preferably may be made available for the user as an application software along with the authentication device, which app being executable on the mobile radio device.

Preferably the installation of the application software is performed by downloading the application software via a third data link to a network-server of a global network preferably the internet.

If the download or a prompt for downloading the application software is performed automatically upon identification of the RFID-data carrier by the NFC-interface, there is no requirement for any special user guide for the activation of the mobile radio device as pay terminal.

Preferably the data link setup of the first data link is performed to the network-server in a global network, most preferably the internet. Although a data link setup could be executed to a network server in a local or private network, however inclusion of the RFID-data carrier in the internet caused by the worldwide net offers more optimal options for the user to take wireless digital payment procedures.

In order to provide for a favorable site-independent access to the network server the data link setup of the first data link to the network-server may be performed via the radio interface specified according to a mobile radio standard. Due to the high net coverage of the different mobile radio networks they present themselves as access networks for the extensive global network. By using a radio interface specified according to a mobile radio standard the user gets access to the network server of the clearing center from almost everywhere.

If there should be no availability of any mobile radio network, there is the option to install an access to an overall network via a WLAN connection.

If need should arise, during or upon launching the application software there can be performed a prompt for entering additional authentication data, for example a finger print, as a condition for establishing the first data link to the network-server, so that for example an individual use of a credit card by several users is possible.

Particularly, if a personal identification document is used as authentication device and the authentication of the data or information stored on the RFID-data carrier of the personal identification document is performed on the authentication server being independent of the clearing center in such a manner, that the authentication of the data stored on the RFID-data carrier is performed by means of a fourth data link to an authentication server, and an authorization performed by the authentication server is communicated to the network-server of the clearing center via a fifth data link, the authentication can be performed independent of the network server. For example the authentication server can be in possession of the governmental authority issuing the personal identification documents.

With respect to an arrangement according to the invention the object is attained in connection with the preamble of claim 16 in that the mobile radio device provides for a data transfer device for data transfer between the RFID-data carrier and the network-server.

The inventive arrangement thus favorably provides for a particular simple structure enabling the use of a conventional mobile radio device as data communications equipment.

Preferably the mobile radio device has a NFC-interface being compatible with a RFID-interface. Along with the upcoming spreading of NFC-enabled mobile radio devices being capable to emulate a RFID-interface the user has the option to access to the network server of the clearing center via the radio network.

In one embodiment of the arrangement the authentication device comprising the RFID-data carrier is embodied as a credit card.

In a further embodiment of the arrangement the authentication device comprising the RFID-data carrier is embodied as a personal identification document.

If additionally to the network-server of the clearing center there is provided for an authentication server independent of the clearing center, and an additional data link is performed between the mobile radio device and the network-server via the authentication server, which additional data link is in parallel to a data link between the mobile radio device and the network-server, the authentication can be performed independent of the network server.

Further favorable embodiments of the method and the arrangement will be evident from the following description and the accompanying drawings:

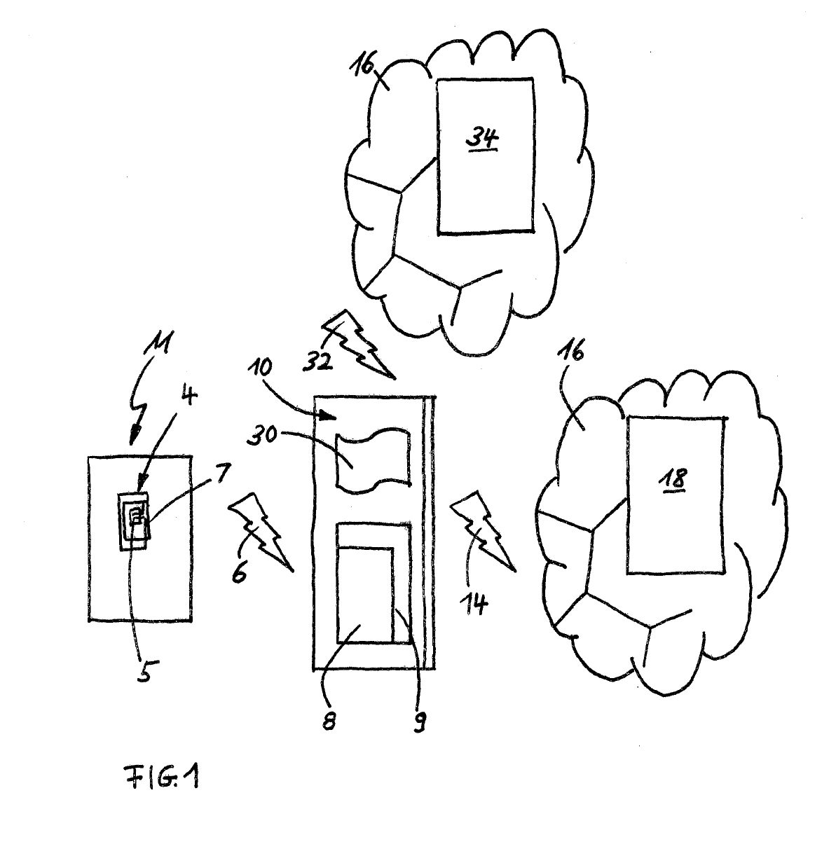

FIG. 1: a schematic illustration of the arrangement according to a first embodiment;

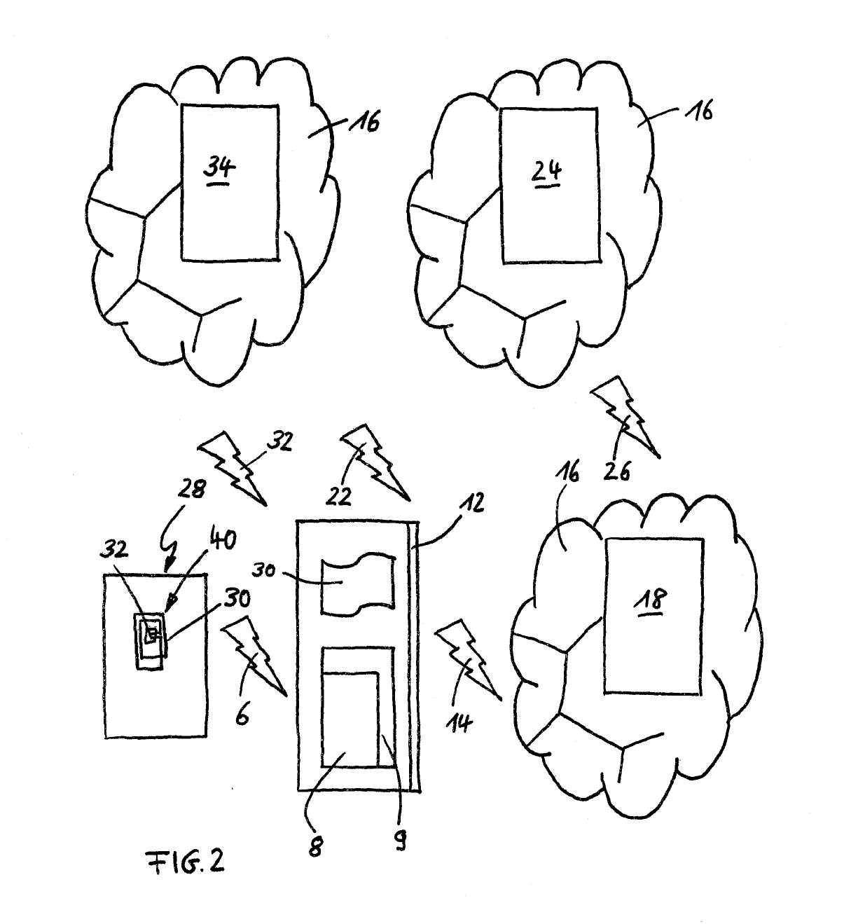

FIG. 2: a schematic illustration of the arrangement according to a second embodiment.

FIG. 1 is a schematic view of an arrangement 2 comprising the substantial components defining the structure of the method. There is shown a RFID-data carrier 4 of a contactless credit card 11 having a chip 5 and a coil as coupling element 7. The chip 5 contains authentication data authenticating the user of the credit card 11. The RFID-data carrier 4 is connected to the RFID-reader device 8 via a contactless (near field-)data link 6, which RFID-reader device 8 being embodied as a NFC-interface 9 integrated or emulated in a mobile radio device 10. In the present example the mobile radio device 10 is embodied as a mobile phone.

Additionally to the NFC-interface 9 the mobile radio device 10 is equipped with a radio interface 12 for establishing a first data link 14 to the network 16 (internet). As part of the network 16 there is installed a network-server 18 of a credit card provider, like Visa, Master, enabling transactions of the credit card provider.

In addition to the first data link 14 between the mobile radio device 10 and the network server 18 of the credit card provider and the second data link 6 between the RFID-data carrier 4 and the mobile radio device 10 which all together provide for a data transfer between the RFID-data carrier 4 and the network server 18 preferably there is a third data link 32 between the mobile radio device 10 and a network server 34 of the internet 16 which data link 32 is installed via the radio interface 12 and which data link 32 enables downloading of an application software 30.

The download or a prompt for downloading the application software 30 is performed automatically upon identification of the RFID-data carrier by the NFC-interface. When launching the application software 30 there is performed a prompt directed to the user of the mobile radio device 10 for entering of additional authentication data, which authentication data can be a finger print or the like, as a condition for installing the first data link 14 to the network-server 18. Simultaneously the mobile radio device 10 is activated by the application software 30 as pay terminal.

The use of the mobile radio device 10 as pay terminal can be performed via the key pad of the mobile radio device 10 so that for example the numerical value of an amount of money to be transferred and the recipients data can be entered.

Upon authentication of the authentication data being transferred to the network server 18 via the mobile radio device 10, which authentication is performed by the network server 18 of the clearing center a release takes place so that a posting- or payment procedure can be processed based on the posting- or payment data being entered in the mobile radio device 10 and transferred to the network server 18 via the first data link 14.

FIG. 2 shows as a further embodiment an arrangement 20, which with the exception of the credit card 11 comprises components of the arrangement 2 as depicted in FIG. 1, id est the mobile radio device 10 and the network server 18, and which like the arrangement 2 installs a data link 32 to a network server in order to download an application software 30 to the mobile radio device 10.

The arrangement 20 shown in FIG. 2 instead of the authentication device embodied as credit card 11 comprises an authentication device embodied as a personal identification document 28 having a RFID-data carrier 40, which RFID-data carrier 40 has a chip containing personal data as authentication data and identifying the proprietor of the personal document and which chip being provided with a coupling element for contactless data transfer.

In addition to the first data link 14 between the mobile radio device 10 and the network server 18 of the credit card provider and the second data link 6 between the RFID-data carrier 4 and the mobile radio device 10, which data links 4 and 6 together provide for a data transfer between the the RFID-data carrier 4 and the network server 18, there is a third data link 32, preferably by means of the radio interface 12, between the mobile radio device 10 and a network server 34 of the internet 16, which third data link 32 provides for a download of an application software 30 to the mobile radio device 10.

Furthermore the arrangement 20 provides for a fourth data link 22 to an authentication server 24 being embodied as network server of the internet 16. The authentication server 24 is connected with the network server 18 of the clearing center via a fifth data link 26.

The authentication data are transferred to the mobile radio device 10 via the second data link 6 and are transferred from the mobile radio device 10 to the authentication server 24 via the fourth data link 22, so that a data transfer to the authentication server 24 is executed via the mobile radio device 10. Upon authentication of the authentication data there is a release for the network server 18 of the clearing center, so that a posting or payment procedure can be performed based on the posting or payment data which data being entered in the mobile radio device 10 and transferred to the network server 18 via the first data link 14.

1. A method for processing a digital payment procedure by using a mobile radio device (10),
wherein the mobile radio device comprises a radio interface (12) providing for a first data link (14) to a network-server (18) of a clearing center,
wherein the mobile radio device comprises an integrated RFID-reader device (8) providing for a second data link (6) to a RFID-data carrier (4, 40) of an authentication device, in such a manner, that a data transfer of authentication data stored on the RFID-data carrier to the network-server (18) of the clearing center is performed by the mobile radio device for posting or payment release.

2. Method according to claim 1,
wherein the authentication device is embodied as a credit card (11) and the authentication of the data or information stored on the RFID-data carrier (4) is performed by the network-server (18) or by an authentication server of the clearing center.

3. Method according to claim 1,
wherein the authentication device is embodied as a personal identification document (28) and the authentication of the data or information stored on the RFID-data carrier (40) is performed by an authentication server (24) independent of the clearing center.

4. Method according to claim 2,
wherein the data transfer between the RFID-data carrier (4, 40) and the RFID-reader device (8) is performed by a NFC-interface (9) which is integrated in the mobile radio device (10), the NFC-interface being compatible with a RFID-interface.

5. Method according to claim 1,
wherein the data link setup of the second data link (6) is performed automatically upon identification of the RFID-data carrier (4, 40) by the NFC-interface (9).

6. Method according to claim 1,
wherein the mobile radio device (10) is activated as pay terminal and input data specifying the posting or payment transaction and being entered into the mobile radio device by means of a data input device are transferred to the network-server (18) of the clearing center via the radio interface (12) of the mobile radio device.

7. Method according to claim 6,
wherein upon reception of the transferred data by the clearing center the network-server (18) transfers the received data to the mobile radio device (10) for confirmation.

8. Method according to claim 6,
wherein the data input is performed by a keypad of the mobile radio device (10).

9. Method according to claim 6,
wherein activation of the mobile radio device (10) as pay terminal and the data link setup of the first data link (14) to the network-server (18) via the radio interface (12) is performed by an application software (30) installed on the mobile radio device.

10. Method according to claim 9,
wherein the installation of the application software (30) is performed by downloading the app via a third data link (32) to a network-server (34) of a global network (16).

11. Method according to claim 10,
wherein the download or a prompt for downloading the application software (30) is performed automatically upon identification of the RFID-data carrier (4, 40) by the NFC-interface (9).

12. Method according to claim 1,
wherein the data link setup of the first data link (14) is performed to the network-server (18) of a global network (16).

13. Method according to claim 1,
wherein the data link setup of the first data link (14) to the network-server (18) is performed via the radio interface (12) specified according to a mobile radio standard.

14. Method according to claim 8,
wherein during or upon launching the application software (30) there is performed a prompt for entering additional authentication data as a condition for establishing the first data link (14) to the network-server (18).

15. Method according to claim 3,
wherein authentication of the data stored on the RFID-data carrier (40) is performed by means of a fourth data link (22) to an authentication server (24), and an authorization performed by the authentication server is communicated to the network-server (18) of the clearing center via a fifth data link (26).

16. An arrangement for processing a digital payment procedure comprising a mobile radio device (10) having a radio interface (12) and an integrated RFID-reader device (8), an authentication device provided with a RFID-data carrier (4, 40) and a network-server (18) of a clearing center, wherein the mobile radio device (10) provides for a data transfer device for data transfer between the RFID-data carrier (4, 40) and the network-server (18).

17. Arrangement according to claim 16,
wherein the mobile radio device has a NFC-interface being compatible with a RFID-interface.

18. Arrangement according to claim 16,
wherein the authentication device comprising the RFID-data carrier (4) is embodied as a credit card (11).

19. Arrangement according to claim 16,
wherein the authentication device comprising the RFID-data carrier (40) is embodied as a personal identification document.

20. Arrangement according to claim 19,
wherein additionally to the network-server (18) of the clearing center there is provided for an authentication server (24) independent of the clearing center, and an additional data link (22, 26) is performed between the mobile radio device (10) and the network-server (18) via the authentication server, which additional data link is in parallel to a data link (14) between the mobile radio device and the network-server (18).
